(19) United States
(12) Patent Application Publication
(10) Pub. No.: US 2013/0048614 A1
(43) Pub. Date: Feb. 28, 2013

(54) METHOD FOR MANUFACTURING SEALING DISKS

(71) Applicants: Francois Chevalley, Winterthur (CH); Jürg Lanz, Muri (CH); Marcel Oberholzer, Bergdietikon (CH)

(72) Inventors: Francois Chevalley, Winterthur (CH); Jürg Lanz, Muri (CH); Marcel Oberholzer, Bergdietikon (CH)

(73) Assignee: Soudronic AG, Bergdietikon (CH)

(21) Appl. No.: 13/583,141

(22) PCT Filed: Jan. 25, 2011
(86) PCT No.: PCT/CH2011/000008

§ 371 Date: Nov. 2, 2012

(30) Foreign Application Priority Data
Mar. 19, 2010 (CH) 414/10

(51) Int. Cl. B23K 31/02; B23K 26/00; B23K 3/00

(52) U.S. Cl. 219/121.6; 228/176; 228/18

(57) ABSTRACT

Sealing disks (44) for producing peel-off lids comprising lid rings having a peel-off foil sealed onto the lid ring are produced in that an annular sealing part made of steel (54) is fastened on a main plate (53) made of copper, for example by electron-beam welding, whereupon the sealing part is hardened by laser hardening. In this way, a sealing disk having good thermal conductivity and high wear resistance can be favorably produced.

### CROSS REFERENCE TO RELATED APPLICATIONS

This application claims the priority of Swiss patent application 0414/10, filed Mar. 19, 2010, the disclosure of which is incorporated herein by reference in its entirety.

### BACKGROUND

The invention is related to a method for manufacturing sealing disks for heat-sealing peel-off foils onto lid rings made of metal, wherein a main plate made of a first metal material and an annular sealing part made of a second metal material are provided and the metal material of the main plate has a higher thermal conductivity than the metal material of the sealing part and the metal material of the sealing part has a higher hardness than the metal material of the main plate. Furthermore, the invention is related to a sealing station according to claim 5 as well as a device for manufacturing peel-off lids according to claim 6.

### PRIOR ART

It is known how to execute lids for can-like or tin-like packaging as metal lids permanently attached on the top of the packaging, having a lid ring with an extraction opening. The latter remains closed until the first usage of the packaging contents by means of a peelable foil which is attached to the lid ring by heat sealing. Such lids are called peel-off lids. The foil on the lid is called peel-off foil and may e.g. be a metal foil, a metal composite foil or a pure plastic foil. An additional lid made of plastic and arranged on top of the metal lid makes it possible to reclose the packaging during the consumption period of the contents.

After filling the container or the can respectively, it is closed by flanging the pre-manufactured peel-off lid to the body of the container or the can respectively.

Known methods or devices respectively, for manufacturing peel-off lids will be explainer in the following in more detail by means of the FIGS. 1 to 9. FIGS. 2 to 8 serve to explain manufacturing steps.

In the sealing station, inside which the peel-off foil is sealed onto the lid ring and, if necessary, the peel-off foil section has beforehand been punched out of a foil web, heated sealing disks are used for the heat sealing. It is already known how to manufacture such sealing disks out of two different metal materials, wherein a sealing part made of a harder material is shrunk on a base of a softer but more thermal conductive metal material. However, this manufacturing with a shrinking joint is complex and may yield an insufficient joint of the two materials.

### DISCLOSURE OF THE INVENTION

It is the objective of the invention to provide an improvement for the manufacturing of sealing disks for the production of peel-off lids.

The solution of the objective consists in case of the above mentioned method in attaching the sealing part to the main plate by means of a welding joint or a soldering joint, whereafter the sealing part is hardened by a laser hardening, or in building the sealing part on the main plate by laser sintering, whereafter the sealing part is hardened, as the case may be, by laser hardening.

The welding is preferably executed as electron beam welding. Alternatively, a diffusion welding may be used.

Preferably copper is used as metal material for the main plate and steel is used as metal material for the sealing part.

Furthermore the objective is solved by means of a sealing station for heat-sealing peel-off foils onto lid rings made of metal according to claim 5 or a device for manufacturing peel-off lids according to claim 6.

### SHORT DESCRIPTION OF THE DRAWINGS

In the following the prior art and further embodiments of the invention are explained in more detail by means of the figures. Thereby it is shown in:

FIG. 1 a schematic side view of a device for manufacturing peel-off lids;

FIG. 2 to FIG. 8 sectors of peel-off lids for an explanation of their manufacturing;

FIG. 9 a schematic view of the punching and attachment of the peel-off foil in the sealing station;

FIG. 10 a section view of a sealing station for the sealing of the peel-off foil onto the lid rings;

FIG. 11 the blank of a sealing disk in a perspective view;

FIG. 12 a section view through the blank of FIG. 11; and

FIG. 13 a section view through a finished sealing disk.

### WAYS OF CARRYING OUT THE INVENTION

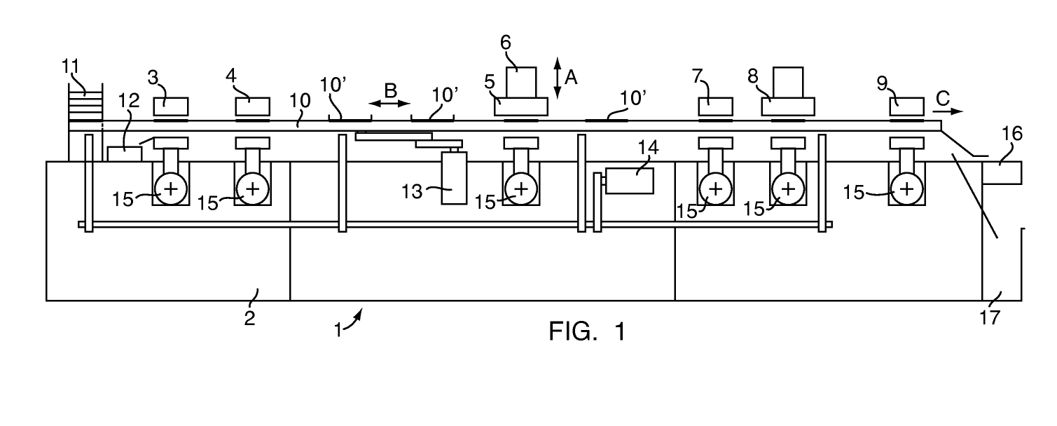

FIG. 1 shows a schematic side view of a device 1 for manufacturing peel-off lids. It has a plurality of processing stations 3 to 9 on a machine frame 2. A transport device 10, 13, 14 transports lid parts and the finished lids in a transport direction which is indicated by the arrow C, from the beginning of the device at the stack 11 until the end of the device where the lids get into the trays 16 or 17 via slides. The lid parts are destacked in a known way from the stack 11 and they get into the transport device. The latter may have two long rails 10, each of which is arranged individually laterally with respect to the objects, which lift up the lid parts or the lids respectively, lying on the trays 10′ or in the stations 3 to 9 respectively, during the lift up of the bars 10 by means of the actuator 14 in the direction of the arrow A and shift them onwards by a distance by an onward motion in the direction of arrow B (oriented in the same direction as arrow C) by means of the crank drive 13. Thereafter the bars are moved downwards in the direction of arrow A, wherein the lid parts and the lids are again laid onto their trays. The bars 10 are then moved backwards below the object tray positions in the direction of arrow B in the opposite direction of arrow C and carry out the described process again. The lid parts or the lids respectively, are idle on their tray positions or are located in the processing stations and are processed there respectively. After a processing step through all processing stations they are again transported. Instead of the described transport device a known transport device with two toothed belts according to WO 2006/017953 is preferably used. Such an endless toothed belt actuator is provided with the length necessary for the number of processing stations and the stepwise motion of the toothed belt which is synchronized with the processing stations is provided by a step motor or servo motor which actuates the toothed belts by means of toothed rolls. The transport device with toothed belts allows the manufacturing of lids with a higher cycle of e.g. 200 lids per minute.

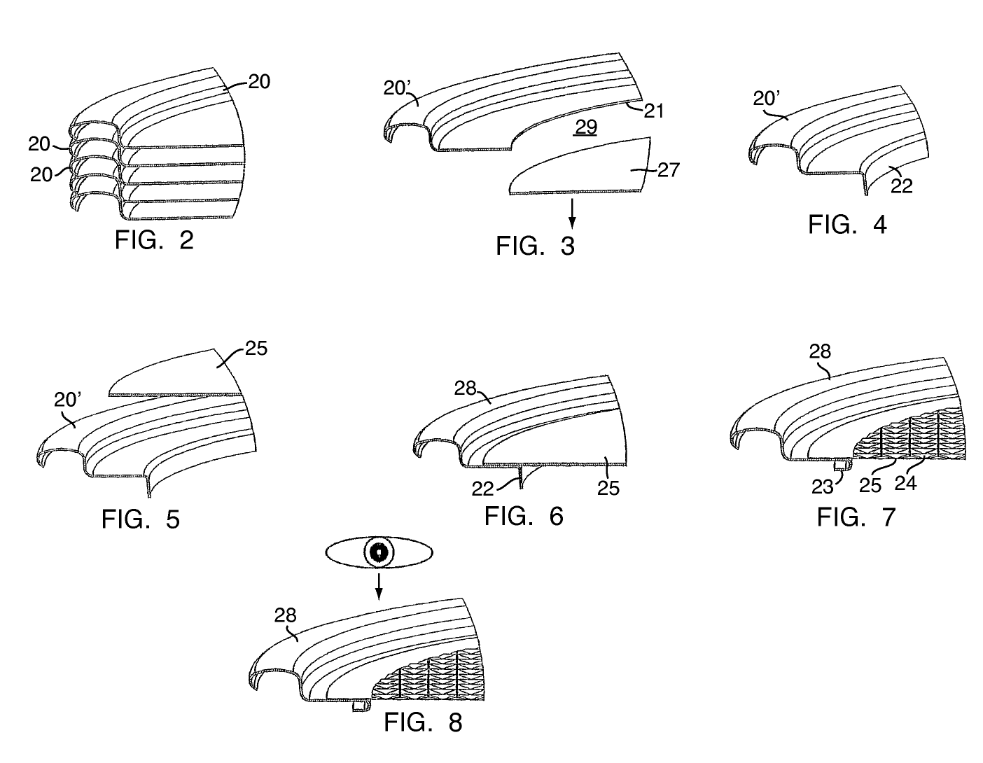

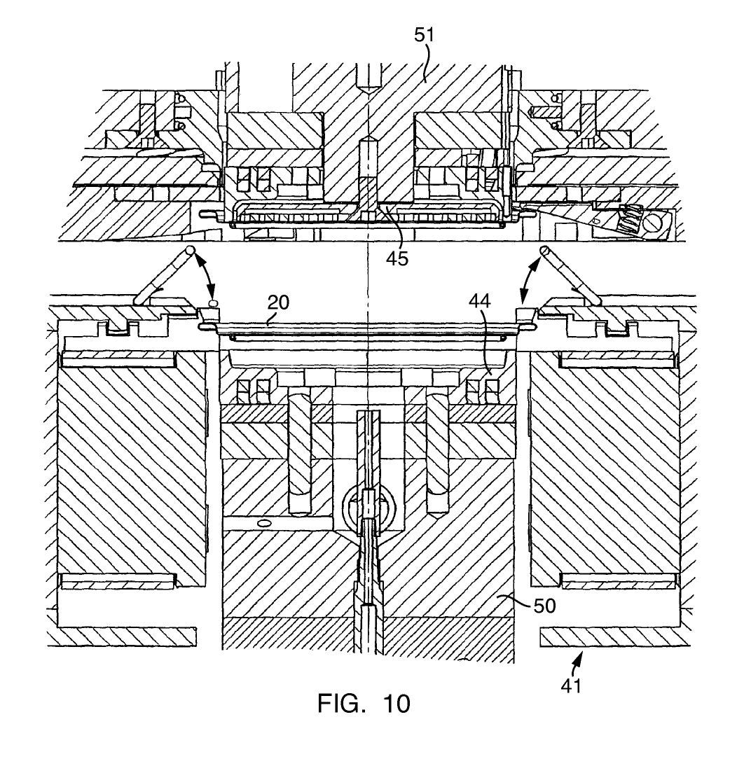

FIG. 2 shows stacked metal lid blanks 20 as they are ready in the stack 11 at the beginning of the transport device. These blanks 20 are e.g. round metal disks with a diameter of e.g. 11 cm. Certainly, other basic shapes like for example square or rectangular disks and other diameters are readily possible. The blanks 20 have already been preformed at their edge, as shown in FIG. 2, in a processing machine which is not shown. In FIG. 2 and the subsequent FIG. 3 to 8 only a sector of the entire disk or the lid respectively, is shown, in order to simplify the figures. In the first processing station 3 of FIG. 1 an opening 29 is punched into the disk by means of a punching processing with an upper tool and a lower tool, this being indicated in FIG. 3, where the edge of the opening is denoted by 21 and the punched out round disk by 27. This disk 27 is disposed of in the container 12 of FIG. 1. By this, an annular lid part 20′ with an opening forming the extraction opening of the finished lid is produced. The punching station 3 is actuated by an actuator 15, as this is the case for the subsequent processing stations. In the processing station 4, a pulling down of the edge 21 is carried out, by which e.g. the shape 22 of the edge shown in FIG. 4 is reached. However, a rolled-in edge section is preferably created, as shown in FIG. 10. Thereafter, the annular lid parts 20′ get into the sealing station 5. In it, a foil section 25 is punched out by punching means 6 and placed above the opening 29 of the lid ring 20′ and attached there by heat sealing, this being visible in FIGS. 5 and 6. The peel-off foil 25, which can be a metal foil or a metal composite foil or a plastic foil, has, knowingly, a sealable plastic layer on its bottom side. The peel-off foil 25 may e.g. be a multiple layer composite foil with plastic layers and aluminium layers, e.g. on the bottom side of the lid a layer of heat sealable polypropylene (PP) and a subsequent layer of PET, being followed by an aluminium layer and having another PET layer on the upper side of the peel-off foil. A possible print is arranged under this PET layer. A further embodiment of the peel-off foil may be a heat sealing paint layer arranged under the lid or on the contents side respectively, being followed by the aluminium layer and the PET layer on the upper side of the lid. Also further embodiments are known to the skilled person and may be used within the scope of the present invention. The needed precut foil 25, which in this example has a round shape, is normally punched out of a wide foil web in the station 5, 6, placed above the middle cavity of the annular disk, wherein the foil is pressed by the sealing station at the edge of the round cavity of the lid part 20′ under the influence of heat, such that the foil 25 is sealed tightly to the metal lid part 20′ by melting and subsequent cooling of the sealable layer. This is reached by means of the heated sealing disks of the sealing station and is known to the skilled person and will therefore not be explained in more detail. If necessary, two sealing stations may be arranged one after the other in transport direction, wherein in the first sealing station the punching out of the foil section and a first sealing step are carried out, not yet producing an entirely tight sealing and in the second sealing station a second sealing is carried out which produces the finished, tight sealing seam. In this case both sealing stations may be equipped with sealing disks according to the present invention. The peel-off lid 28 is thereby formed. A cooling station may possibly be provided for the cooling. The foil 25 may be provided with a stamp 24 (FIG. 7) in the processing station 8, particularly if it is a metal foil. If the peel-off foil is provided with a peel-off tab, the tab may then be folded back according to the prior art, such that it comes to lie on the lid. The finished lids are submitted to a leakage inspection in an inspection station 9 which is to be considered a processing station. If the foil is tightly attached to the lid ring, the lid thereby ends up in the tray 16 for the finished lids. If a leak is detected, the lid ends up in the waste container 17 via the other shown slide.

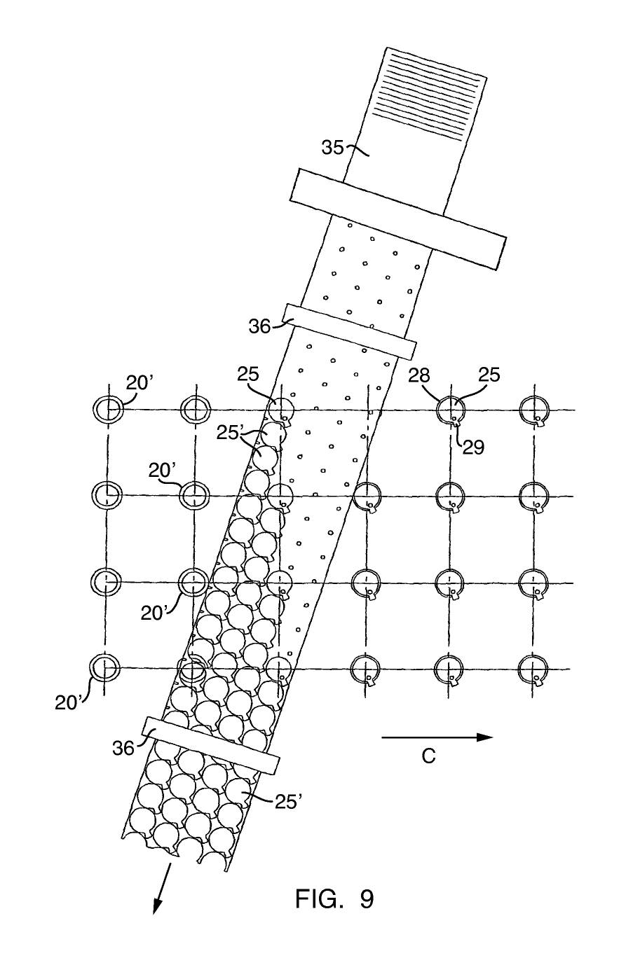

FIG. 9 shows in a coarse schematic way a part of a device for manufacturing peel-off lids from above, which e.g. is a device according to FIG. 1. Four rows of lid parts 20′ or lids 28 respectively, are transported in a parallel manner in the transport direction C by means of the transport device not shown in FIG. 9. In the area of the sealing station, which is not shown here as an apparatus (similarly to the sealing station 5 of FIG. 1), a belt 35 of the peel-off foil material enters the sealing station and is punched there, in order to form the foil sections 25 with the peel-off tab 29 which are sealed onto the lid ring directly after the punching. The punch pattern is thereby chosen in a way such that as little as possible punching debris remains left. The foil sections 25 for the uppermost row of the lid rings 20′ with respect to FIG. 9 are punched out on the belt in this example in the row which is leftmost at the edge of the belt. The empty positions 25′ are then left. The foil sections 25 for the second uppermost row of lid rings 20′ are punched out in the row left of the longitudinal middle axis of the belt 35 and the foil sections 25 for the second lowermost row of lid rings 20′ are punched out in the row right of the longitudinal middle axis of the belt 35. The foil sections 25 for the lowermost row of lid rings 20′ are punched out in the rightmost row of the belt 35. The punching of the individual foil sections 25 in the sealing station may e.g. be controlled by print marks on the belt. The belt 35 may be transported by means of actuating roller 36 or in another known way. The punched out foil sections are then each sealed onto the corresponding lid ring, as known by the skilled person.

FIG. 10 shows a section view of a known sealing station as used for the sealing of the peel-off foil onto the lid ring. A bottom part of the sealing station 41 has a carrier 50 for the lower sealing tool, which is preferably formed by a sealing disk 44 manufactured according to the invention, which acts upon the peel-off lid ring from the bottom side or from the sealable side of the peel-off foil respectively. Furthermore, the sealing station has an upper part 51 which carries the upper tool or an upper sealing disk 45, which is preferably also manufactured in a way according to the invention.

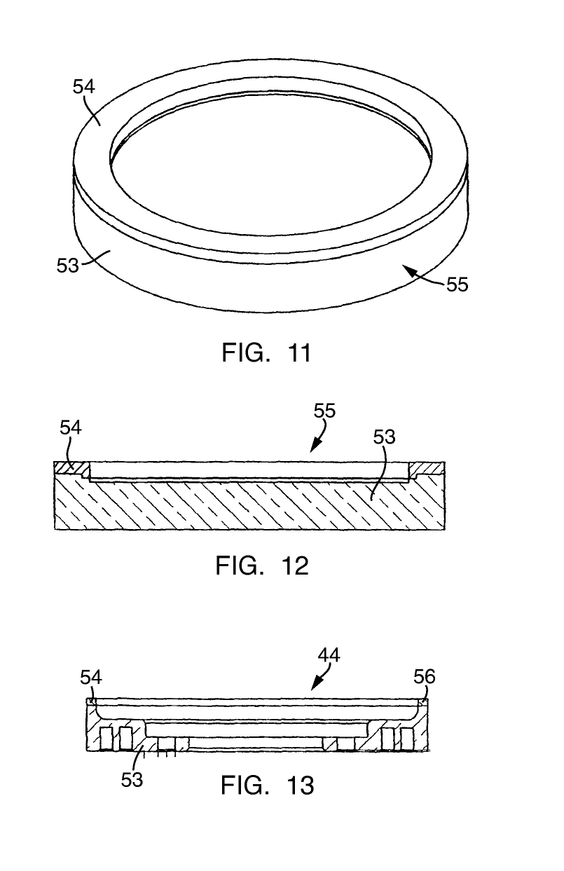

In the following the production of such sealing disks is explained. In FIGS. 11 and 12 a blank 55 for forming the sealing disk is shown, having been already formed by two different metal materials by having connected a main plate 53 made of a good thermally conductive metal, particularly of copper or bronze, with an annular sealing part 54 made of a harder metal material, particularly steel, by electron beam welding. The electron beam welding is known and provides the necessary welding energy of electron accelerated into the process zone by high voltage. When the electrons impact, they transform a major part of their kinetic energy in heat. The welding is performed around the blank along the joint line, as indicated by arrow F in FIG. 12. Welding devices for carrying out this welding are known to the skilled person and they are available on the market. After that, the blank is processed, e.g. by turning, milling, grinding, in order to generate the desired end shape of a sealing disk 44 which is shown as an example in FIG. 13 in section view. Thereafter, if necessary also before this processing, the actual sealing surface 56 made of steel is hardened by laser beam hardening. Laser beam hardening is known as exterior layer hardening by means of lasers, particularly high energy diode lasers. The laser beam temporarily heats up a locally limited thin surface layer until the austenitizing temperature of steel (material-dependent around 900 degrees Celsius up to 1400 degrees Celsius). Because of the low heat input and of the fast heat dissipation inside the sealing disk, a self-quenching is the result as soon as the heat input is finished. This leads to a “freezing” of the hardened structure.

A further suitable and known welding method is the diffusion welding, in case of which the parts to be connected are joined with high pressure. This can be done in vacuum or in a protecting gas. Furthermore, the parts can thereby be heated. In the finished state, the result is an atomic joint of the surfaces by plastic and local deformation in a micro-range.

As an alternative to the step of joining by welding the step of joining by soldering may take place. The other above mentioned steps remain the same. The vacuum soldering is a joining of the materials made mostly of different materials, is done in vacuum under lowered pressure at temperatures up to 900° C. Thereby, the vacuum helps minimizing the oxidation of both parts and of the solder and avoids cavities.

As an alternative to the above steps of joining two parts to form the sealing disk, it is possible to proceed in such a way that the annular sealing part is build on the main plate by laser sintering. This is also called selective laser sintering (SLS). The sealing disk is thereby build layer by layer out of metal powder. The metal powder is thereby applied to the main plate, e.g. in a layer of 0.001 to 0.2 millimeters, and the layers are each sintered by means of a laser. Here, the use of a metal powder without adding a binder is preferred, wherein the powder is particularly entirely melted by a CW-laser. This method variant is also called “selective laser melting” (SLS). However, it is also possible to use a weaker melting, in case of which the powder particles are only partially melted. In case of this variant of building the sealing disk by laser sintering it is also possible to optionally do without the subsequent laser hardening.

Sealing disks for manufacturing peel-off lids out of lid rings with a peel-off foil sealed thereon are thus manufactured by attaching an annular sealing part, preferably made of steel, on a main plate which consists e.g. of copper, by electron beam welding or diffusion welding and alternatively by vacuum soldering, whereafter the sealing part is hardened by laser hardening. Alternatively, a build up of the sealing part by laser sintering, as the case may be without subsequent laser hardening, is carried out. In this way a sealing disk with a very high thermal conductivity and high wear resistance can be produced in a low priced way. The high thermal conductivity of such sealing disks allows high cycle rates with a good and continuous sealing quality for sealing stations or for the device for manufacturing peel-off lids. The temperature regulation in the sealing station or in the device for manufacturing peel-off lids is additionally simpler because the step response to the heating command occurs faster. The hardened sealing disk surface avoids wear in the sealing station and the device, such that a contamination and deformations associated therewith are avoided.

1. Method for manufacturing sealing disks for heat-sealing peel-off foils onto lid rings made of metal, wherein a main plate made of a first metal material and an annular sealing part made of a second metal material are provided and the metal material of the main plate has a higher thermal conductivity than the metal material of the sealing part and the metal material of the sealing part has a higher hardness than the metal material of the main plate, characterized in that the sealing part is attached to the main plate by means of a welding joint or a soldering joint, whereafter the sealing part is hardened by a laser hardening, or in that the sealing part is built on the main plate by laser sintering, whereafter the sealing part is hardened, as the case may be, by laser hardening.

2. Method according to claim 1, characterized in that the welding is an electron beam welding or a diffusion welding.

3. Method according to claim 1, characterized in that a vacuum soldering is carried out for the soldering joint.

4. Method according to claim 1, characterized in that copper is used as the first metal material for the main plate and steel is used as the second metal material for the sealing part.

5. Sealing station for heat-sealing peel-off foils onto lid rings made of metal, comprising an upper and a lower sealing disk manufactured by the method according to claim 1.

6. Device for manufacturing peel-off lids with at least a sealing station according to claim 5.
